(19) United States
(12) Patent Application Publication
(10) Pub. No.: US 2025/0272486 A1
(43) Pub. Date: Aug. 28, 2025

(54) METHOD AND DEVICE FOR GENERATING SCRIPT, ELECTRONIC DEVICE, STORAGE MEDIUM AND PRODUCT

(71) Applicant: Beijing Youzhuju Network Technology Co., Ltd., Beijing (CN)

(72) Inventors: Xiao WANG, Beijing (CN); Wen ZHOU, Beijing (CN); Ping SONG, Beijing (CN); Rongchang XIE, Beijing (CN); Chen DU, Beijing (CN); Ya LI, Beijing (CN); Rong ZHAO, Beijing (CN); Yan WANG, Beijing (CN); Chen LI, Beijing (CN); Chao WANG, Beijing (CN); Caiyi WANG, Beijing (CN)

(21) Appl. No.: 19/066,560

(22) Filed: Feb. 28, 2025

(30) Foreign Application Priority Data
Feb. 28, 2024 (CN) 202410224804.3

(51) Int. Cl. G06F 40/205; G06Q 30/02

(52) U.S. Cl. CPC G06F 40/205; G06Q 30/02

(57) ABSTRACT

The invention provides a script generation method and device, electronic equipment, a storage medium and a product. The method includes the following steps: determining product information of a target product, wherein the script is related to the target product; according to the product information, obtaining at least one reference script related to the target product; and according to the product information and the at least one reference script, generating a target script of the target product.

### CROSS-REFERENCE TO RELATED APPLICATIONS

This application is based on and claims the benefit of priority to the Chinese patent application No. 202410224804.3 filed on Feb. 28, 2024, which is hereby incorporated by reference in its entirety into the present application.

### TECHNICAL FIELD

The present disclosure relates to the field of computer technologies and, in particular, to a method for generating a script, an apparatus, an electronic device, a storage medium, and a product.

### BACKGROUND

With the development of Internet technologies, e-commerce services have become commonly used services for users. In e-commerce service scenarios, products may be introduced through scripts. A product script may be a text used to describe a product, and may accurately and concisely present the information carried therein to a user. Most of a user's knowledge about a product comes from texts, and the description in texts can help the user accurately grasp the features of the product and better understand the product.

In the related art, the script used to describe a product mainly depends on manual writing. For example, the script is written by a professional.

### SUMMARY

In a first aspect, the present disclosure provides a method for generating a script, including:
determining product information of a target product, the script being related to the target product;
obtaining at least one reference script related to the target product according to the product information; and
generating a target script of the target product according to the product information and the at least one reference script.

In a second aspect, the present disclosure provides an apparatus for generating a script, including:
a determination module configured to determine product information of a target product, the script being related to the target product;
an obtaining module configured to obtain at least one reference script related to the target product according to the product information; and
a generation module configured to generate a target script of the target product according to the product information and the at least one reference script.

In a third aspect, the present disclosure provides an electronic device, including a memory, a processor, and a computer program stored in the memory and executable by the processor. When the processor executes the program, the method according to the first aspect is performed.

In a fourth aspect, the present disclosure provides a non-transitory computer-readable storage medium storing computer instructions, where the computer instructions are used to cause a computer to perform the method according to the first aspect.

In a fifth aspect, the present disclosure provides a computer program product including computer program instructions, where the computer program instructions, when executed on a computer, cause the computer to perform the method according to the first aspect.

### BRIEF DESCRIPTION OF THE DRAWINGS

In order to more clearly illustrate the technical solutions in the present disclosure or the related art, the following will briefly introduce the drawings that need to be used in the description of the embodiments or the related art. Obviously, the drawings in the following description are only some embodiments of the present disclosure. For those of ordinary skill in the art, other drawings can be obtained based on these drawings without paying any creative effort.

FIG. 1 is a schematic diagram of an example system according to some embodiments of the present disclosure.

FIG. 2 is a schematic diagram of an example page according to some embodiments of the present disclosure.

FIG. 3 is a schematic diagram of another example page according to some embodiments of the present disclosure.

FIG. 4 is a schematic diagram of another example page according to some embodiments of the present disclosure.

FIG. 5 is a schematic diagram of another example page according to some embodiments of the present disclosure.

FIG. 6 is a flowchart of an example method for generating a script according to some embodiments of the present disclosure.

FIG. 7 is a schematic structural diagram of an example apparatus for generating a script according to some embodiments of the present disclosure.

FIG. 8 is a schematic structural diagram of an example electronic device according to some embodiments of the present disclosure.

### DETAILED DESCRIPTION

In order to make the objectives, technical solutions, and advantages of the present disclosure clearer, the following will further describe the present disclosure in detail with reference to the drawings and in combination with specific embodiments.

It should be noted that, unless otherwise defined, the technical terms or scientific terms used in the embodiments of the present disclosure should have general meanings as understood by those of ordinary skill in the art to which the present disclosure belongs. The words “first”, “second”, and similar words used in the embodiments of the present disclosure do not indicate any order, quantity, or importance, but are only used to distinguish different components. Words such as “include” or “include” mean that the element or item appearing before the word covers the element or item listed after the word and its equivalents, without excluding other elements or items. Words such as “connect” or “connected” are not limited to physical or mechanical connections, but may include electrical connections, whether direct or indirect. “Upper”, “lower”, “left”, “right”, etc. are only used to indicate the relative positional relationship, and when the absolute position of the described object changes, the relative positional relationship may also change accordingly.

It may be understood that before using the technical solutions of the embodiments of the present disclosure, the user will be informed of the type, scope of use, use scenarios, etc. of the involved personal information in an appropriate manner, and the user's authorization will be obtained.

For example, in response to receiving an active request from the user, prompt information is sent to the user to clearly inform the user that the operation requested to be performed will require the acquisition and use of the user's personal information. Thereby, the user may choose, according to the prompt information, whether to provide the personal information to software or hardware such as the electronic device, the application, the server, or the storage medium that performs the operations of the technical solutions of the present disclosure.

As an optional but non-limiting implementation, in response to receiving the active request from the user, the prompt information may be sent to the user in the form of a pop-up window, and the prompt information may be presented in the form of text in the pop-up window. In addition, the pop-up window may also include a selection control for the user to select to “agree” or “disagree” to provide the personal information to the electronic device.

It can be understood that the above process of notifying and obtaining the user's authorization is only illustrative, and does not limit the implementations of the present disclosure. Other methods that meet relevant laws and regulations may also be applied to the implementations of the present disclosure.

As described in the background section, in the related art, the script used to describe a product mainly depends on manual writing. For example, the script is written by a professional, and the efficiency is relatively low.

A script used to describe a product is generally applied in a video including content related to the product (for example, a short video introducing the product). In the production process of the video, if the script is written manually, there exist problems such as lack of high-quality sources of inspiration, lack of scriptwriting capabilities, being unclear about development trends of high-quality materials in the industry, and low quantity and efficiency of produced videos.

For example, a professional needs to search for information according to the category of a product, and conceive creatively to write the script. At the same time, the professional also needs to search and summarize the features of the scripts in existing videos by himself/herself, and optimize the written script in combination with the features.

It can be seen that the time and labor cost of writing a script manually are relatively high, and the accuracy of manually searching and summarizing the features of a video may be biased, which results in the inability of the manually written script to help users better understand the product.

After a professional writes a script, in a process of producing a video using the written script, after shooting the material used to produce the video offline, the professional also needs to upload the material online and carry out secondary creation on the video editing platform. Therefore, whether it is the creation of a script or the creation of a video, the labor and time costs are relatively high.

In view of this, the present disclosure provides a method for generating a script, an apparatus, an electronic device, a storage medium, and a product. The method includes: determining product information of a target product, the script being related to the target product; obtaining at least one reference script related to the target product according to the product information; and generating a target script of the target product according to the product information and the at least one reference script. Through the above method, a script of a target product can be automatically generated, without manually writing the script, thereby improving the efficiency of producing the script.

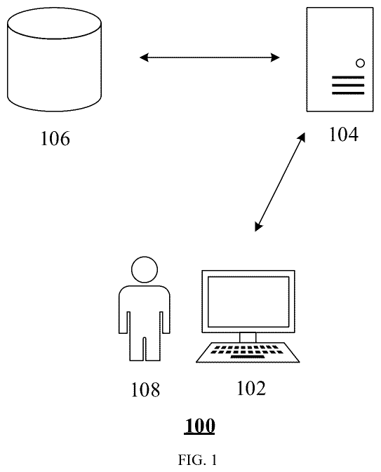

FIG. 1 is a schematic diagram of an example system 100 according to some embodiments of the present disclosure. The system 100 may be a system for implementing script generation.

As shown in FIG. 1, taking the method for generating a script performed jointly by a terminal device and a server as an example, the system 100 may include a terminal device 102, a server 104, and a database 106. The terminal device 102 is connected to the server 104 through a network, such as through a wired or wireless network connection. An apparatus for implementing script generation may be integrated in the terminal device 102. The database 106 is connected to the server 104 through a network, such as through a wired or wireless network connection. The database 106 may store data used to process requests for generating a script, etc.

Various applications (abbreviated as APPs) may be installed on the terminal device 102, such as image processing applications, video conference application programs, reading application programs, video application programs, social application programs, payment application programs, web browsers, instant messaging tools, etc., and these applications may all be used to display content, such as the generated script.

The terminal device 102 here may be hardware or software. If the terminal device 102 is hardware, it may be various electronic devices with a display screen, including but not limited to smart phones, tablet computers, e-book readers, MP3 players, laptop computers, desktop computers (PC), etc. If the terminal device 102 is software, it may be installed in the above-listed electronic devices. It may be implemented as multiple pieces of software or software modules (for example, to provide distributed services), or may be implemented as a single piece of software or software module. There is no specific limitation here.

The server 104 may be a server that provides various services, such as a background server that supports various applications displayed on the terminal device 102. The database 106 may also be a database that provides various services. It may be understood that in a case where the server 104 may implement a related function of the database 106, the database 106 may not be set up in the system 100.

The server 104 and the database 106 here may also be hardware or software. If they are hardware, they may be implemented as a distributed server cluster composed of multiple servers, or may be implemented as a single server. If they are software, they may be implemented as multiple pieces of software or software modules (for example, to provide distributed services), or may be implemented as a single piece of software or software module. There is no specific limitation here.

It should be noted that the method for generating a script provided by the embodiments of the present disclosure may be performed by the system 100. Specifically, it may be performed through interaction among the terminal device 102, the server 104, and the database 106. It may be understood that in the case where the terminal device 102 has the functions of the server 104 and the database 106, the terminal device 102 may also perform the method. It should be understood that the number of terminal devices 102, users 108, servers 104, and databases 106 in FIG. 1 is only illustrative. According to actual needs, there may be any number of terminal devices, users, servers, and databases.

In an example application scenario, a user 108 may input product information through a terminal device 102. The terminal device 102 may send the product information to the server 104 in response to receiving the product information. The server 104 may acquire information related to a target product from the database 106 according to the product information, and generate a target script used to describe the target product according to the information. After generating the target script, the server 104 may return the target script to the terminal device 102, so that the terminal device 102 displays the generated script to the user 108.

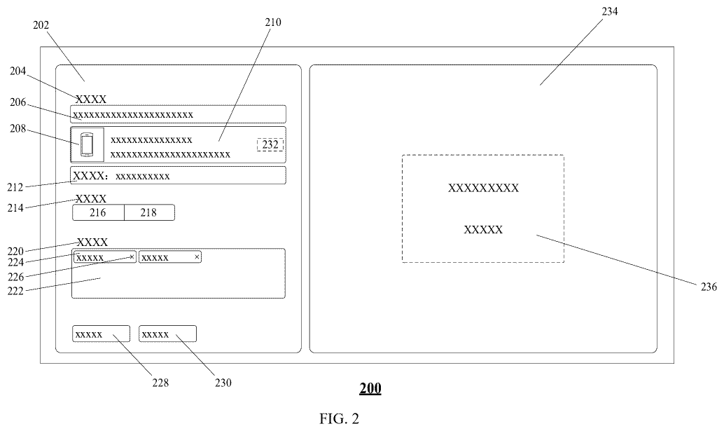

FIG. 2 is a schematic diagram of an example page 200 according to some embodiments of the present disclosure. The page 200 may be a target page.

The page 200 may be used to generate a script. As shown in FIG. 2, in some embodiments, the page 200 may include a first sub-page 202 and a second sub-page 234. In the first sub-page 202, a user may input, through a terminal device, product information of a target product in an input box 206 (e.g., a first input box) to generate a script related to the target product through the page 200. In some embodiments, the terminal device may determine the product information in response to receiving the product information of the target product through the input box 206, and acquire product materials corresponding to the product information in a database according to the product information.

As shown in FIG. 2, in some embodiments, the first sub-page 202 may include an information box 210. After acquiring the product materials, the terminal device may display the content in the product materials in the information box 210. The product materials may be content related to the target product, such as a product details page. For example, the product materials may include information such as a picture of the product, a product name, and a title of the product materials. In some embodiments, the picture of the product may be displayed at the location 208 of the information box 210. Information such as the title of the product materials may be displayed in the information box 210.

In some embodiments, the product materials acquired by the terminal device according to the product information of the target product may include multiple product materials related to the target product. In response to the user believes that the product materials currently displayed in the information box 210 do not match the target product, the user may click a control 232 through the terminal device to delete the product materials currently displayed in the information box 210. In some embodiments, the terminal device may delete the product materials currently displayed in the information box 210 in response to a triggering instruction of the control 232, and display the content of other product materials related to the target product in the information box 210.

The product information of the target product may be a product identification (ID). The user may input the product identification in the input box 206 through the terminal device. In some embodiments, the terminal device may acquire the product materials corresponding to the product identification in the database according to the product identification in response to receiving the product identification through the input box 206. As shown in FIG. 2, in some embodiments, the terminal device may display, in the information box 210, information such as a picture of the product corresponding to the product materials and a title of the product materials in response to acquiring the product materials corresponding to the product identification. The terminal device may also display the product name in the input box 212. In some embodiments, a title name 204 of the input box 212 may be displayed above the input box 212. For example, the title name 204 may include words such as “product information” to prompt the user that he/she may input the product information of the target product in the input box 206.

The user may also input the name of the target product in the input box 212 through the terminal device, so that the terminal device may acquire product materials related to the name in the database according to the name of the target product. As an optional embodiment, the terminal device may acquire the product materials corresponding to the name according to the name of the target product in response to receiving the name of the target product through the input box 212. Concurrently, the terminal device may display, in the information box 210, information such as a picture of the product corresponding to the product materials and a title of the product materials, and display, in the input box 206, the identification of the product corresponding to the product materials.

As shown in FIG. 2, the first sub-page 202 may further include an input box 222 (e.g., a first input box). In some embodiments, the terminal device may parse the acquired product materials to obtain reference product information related to the product materials. In this way, a product script that closely matches the target product may be automatically generated according to the reference product information. In some embodiments, the reference product information may include first information related to a product feature. The terminal device may display the first information in the input box 222 in response to acquiring the reference product information. In this way, the generated script based on the product features related to the target product extracted from the product materials can express as many relevant features of the target product as possible, so that the user can accurately understand the features of the target product.

As shown in FIG. 2, in some embodiments, the first information related to the product feature may be displayed in the input box 222 in the form of a label 224. There may be one or more pieces of the first information, and each piece of the first information corresponds to a label 224 respectively. Concurrently, text content corresponding to the first information may be displayed on the label 224, so that the user can clearly know the product features extracted from the product materials. The label 224 may include a control 226. The user may click the control 226 through the terminal device to adjust the content of the first information related to the product feature automatically parsed from the product materials. For example, the user may click the control 226 through the terminal device to delete the first information that is not highly relevant to the product feature. In some embodiments, the terminal device may delete the label 224 corresponding to the control 226 in response to a triggering instruction of the control 226.

The user may also input, through the terminal device, information included in the script that the user expects to generate or information that the user believes is related to the features of the target product in the input box 222. In some embodiments, the terminal device may generate, in response to receiving input information through the input box 222, a label corresponding to the input information according to the input information, and display the label in the input box 222. In this way, the user may adjust the information in the input box 222 obtained by parsing the product materials according to the demand, so that the script generated according to the information in the input box 222 closely matches the user's needs, and the generated script can describe the features of the target product more accurately.

In some embodiments, a title name 220 of the input box 222 may also be displayed above the input box 222. For example, the title name 220 may be “product features” to prompt the user of the effect of the information included in the input box 222.

After the user inputs the product information in the input box 206 or the input box 212 through the terminal device, for example, after the user inputs the product identification in the input box 206 or the product name in the input box 212 through the terminal device, in some embodiments, the terminal device may acquire at least one reference script related to the target product from the database according to the product information input by the user, and generate a target script of the target product according to the product information and the at least one reference script. In this way, after the user inputs the product information, the terminal device may present the automatically generated script to the user, without manual writing, thereby saving labor costs and improving the efficiency of producing the script.

After the terminal device acquires at least one reference script according to the product information, in some embodiments, the at least one reference script may be parsed to obtain reference script information of the at least one reference script. Then, the terminal device may generate the target script according to the product information and the parsed reference script information. In some embodiments, a trained model (e.g., a large language model (LLM)) may be used, and the product information and the parsed reference script information may be used as inputs of the model, so that the target script may be automatically generated using the model. In this way, the target script is automatically generated using the model according to the input product information and reference script information, which improves the efficiency of producing the script. At the same time, there is no need to manually write the script, which reduces the labor cost.

The reference script information may include information such as a reference script structure, a reference script style, a reference script type, etc. The reference script structure may be used to represent the main content included in the reference script. For example, if the reference script includes a product function and a product feature, the reference script structure may be represented as “product function+product feature”. In this way, based on the model for generating the script, the reference script structure is used as the benchmark, and the target script may be automatically generated using the product information, which improves the efficiency of producing the script, and reduces the time and labor cost of manually writing the script. At the same time, the threshold of producing the script is reduced, and users without scriptwriting basis may also produce the script through the method provided by the embodiments of the present disclosure.

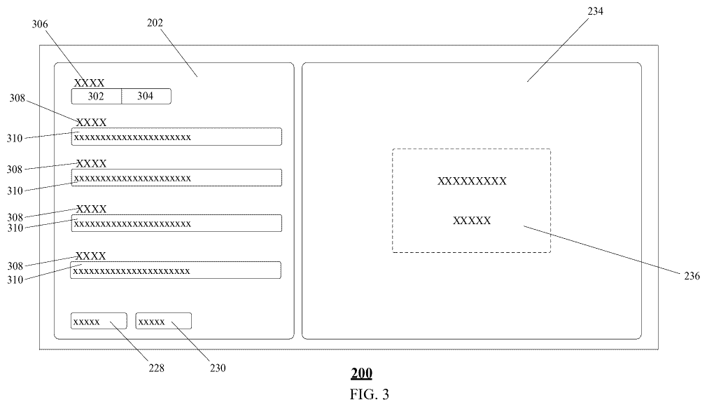

FIG. 3 is a schematic diagram of another example page 200 according to some embodiments of the present disclosure.

As shown in FIG. 3, the first sub-page 202 may further include an input box 310 (e.g., a second input box). The number of the input box 310 may be one or more, which is not limited in the present disclosure. In some embodiments, the reference product information may further include second information related to a product applicable scenario. The terminal device may display the second information in the input box 310 after parsing the product materials to obtain the second information. For example, the input box 310 may include an input box for displaying an applicable scenario of the script and an input box for displaying a suitable audience of the script. After parsing the product materials to obtain the second information related to the applicable scenario and the suitable audience, the terminal device may display the second information in the corresponding input box, and in response to generating the script, the second information may be used to generate a script that closely matches the applicable scenario and the suitable audience.

The user may also input information in the input box 310 through the terminal device according to the demand. For example, the user may input, through the terminal device, information related to the applicable scenario and the suitable audience of the script in the input box 310. In some embodiments, the terminal device may generate a target script that more closely matches the user's needs according to the first information, the second information, and the input information in response to receiving the input information through the input box 222 and/or the input box 310.

In some embodiments, a title name 308 corresponding to the information displayed in the input box may be displayed above the input box 310. For example, a title name of the applicable scenario may be displayed above the input box for displaying or receiving the applicable scenario information, and a title name of the suitable audience may be displayed above the input box for displaying or receiving the suitable audience, to prompt the user of the content of the information displayed or received in each input box 310.

It may be understood that since the content that may be accommodated in the first sub-page 202 is limited, the user may use the drop-down scroll bar to display the input box 310 on the first sub-page 202.

Referring back to FIG. 2, the first sub-page 202 may further include options 216, 218 (e.g., first options). In some embodiments, the options 216, 218 may be used to switch an application scenario of the target script. For example, the application scenario may include a video and a live streaming room. The user may click the option 216 or the option 218 through the terminal device to switch the current application scenario to a target application scenario. In some embodiments, the terminal device may generate, in response to switching to the target application scenario through the option 216 or the option 218, a target script corresponding to the target application scenario according to the reference product information and the at least one reference script. In this way, the user can switch the application scenario of the generated target script by clicking the option 216 or the option 218 through the terminal device, which is convenient for the user to adjust the target script to be generated according to the demand.

It should be noted that the number of the options 216, 218 is only exemplary. In practical application, the first sub-page may include more options corresponding to different application scenarios to provide the user with more choices of application scenarios. The present disclosure does not limit the number of options here.

In some embodiments, a title name 214 may also be displayed above the options 216, 218. For example, the title name 214 may be “application scenario”. In this way, the user may be prompted of the effect of the options 216, 218 through the title name 214.

As shown in FIG. 2, the first sub-page 202 may further include a control 228 (e.g., a first control) for triggering a script generation operation. The page 200 may further include a second sub-page 234. After parsing the product materials to obtain the reference product information and acquiring at least one reference script according to the product information, the user may click the control 228 through the terminal device, so that the terminal device may generate the target script according to the reference product information and the at least one reference script. In some embodiments, the terminal device may generate the target script according to the reference product information and the at least one reference script in response to a triggering instruction of the control 228. In this way, the user may produce the target script by inputting the product information and clicking the control 228, and users without scriptwriting basis may also produce the script using the method provided by the embodiments of the present disclosure, which greatly reduces the threshold of writing the script.

Before the user clicks the control 228 through the terminal device, prompt information 236 may be displayed in the second sub-page 234. In some embodiments, the prompt information 236 includes guidance information for script generation, to guide the user on how to automatically generate the script through the functions provided by the page 200.

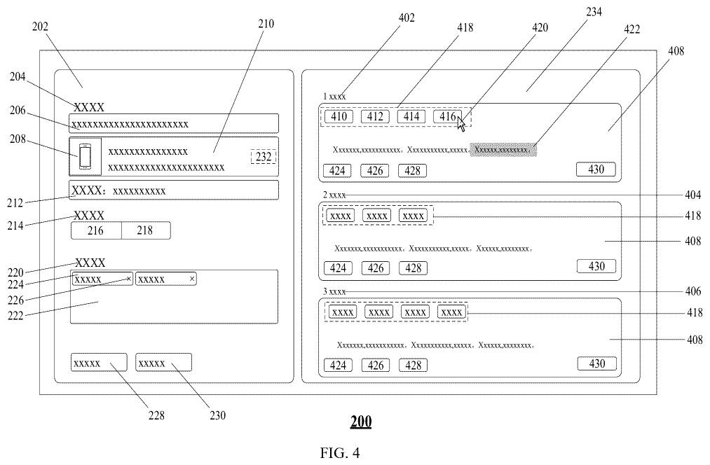

FIG. 4 is a schematic diagram of another example page 200 according to some embodiments of the present disclosure.

After the control 228 is triggered, the terminal device may generate the target script according to the reference product information and the at least one reference script. In some embodiments, the generated target script may be displayed in the second sub-page 234. As shown in FIG. 4, the second sub-page 234 may include at least one script display box 408. The target script may be displayed in the script display box 408. Concurrently, a script structure 418 corresponding to the target script may also be displayed in the script display box 408, so that the user may know the main content included in the target script.

As shown in FIG. 4, in some embodiments, the script structure 418 may include at least one label (e.g., labels 410, 412, 414, 416). The text corresponding to the main content included in the target script may be displayed on each label. In some embodiments, the order of the labels included in the script structure 418 may correspond to the structure of the content in the target script.

The user may control, through the terminal device, the cursor 420 to move to the position of the target label in the at least one label, so that the content in the target script corresponding to the target label is highlighted. In some embodiments, the terminal device may highlight the script content in the target script that corresponds to the target label in response to a triggering instruction of the target label in the at least one label. For example, as shown in FIG. 4, when the cursor 420 moves to the position of the target label 416, the script content 422 corresponding to the target label 416 is highlighted (as shown in FIG. 4, the part with the gray background in the target script). By triggering the target label to highlight the corresponding script content, it is convenient for the user to find the script content corresponding to each label in the script structure 418.

The second sub-page 234 may further include a control 430 for triggering a video generation operation. In some embodiments, the control 430 may be located in the script display box 408 corresponding to each target script, so that the user may click the control 430 corresponding to the target script through the terminal device, so that the terminal device may generate a target video including the target script according to the target script. In this way, there is no need for the user to shoot materials offline and then upload the materials online for editing to produce the video. The user may click the control 430 through the terminal device to generate the target video including the target script, which improves the efficiency of producing the video, while reducing the labor and time costs of video production.

As shown in FIG. 4, the script display box 408 may further include a control 424 for saving the target script. The user may click the control 424 through the terminal device to save the target script to the database. In some embodiments, the terminal device may save the target script in the script display box 408 where the control 424 is located to the database in response to a triggering instruction of the control 424. In this way, the user may save the target script that meets the demand to the database, so that the subsequent script generation may have more materials for reference.

As shown in FIG. 4, the script display box 408 may also include a control 426 for editing the target script. The user may click the control 426 through the terminal device to enable the editing function of the target script. In some embodiments, the terminal device may enable the editing function of the target script in response to a triggering instruction of the control 426. In this way, the user may adjust the content of the target script according to the demand, so that the generated target script closely matches the user's needs.

As shown in FIG. 4, the script display box 408 may also include a control 428 for copying the target script. The user may click the control 428 through the terminal device to copy the generated target script. In some embodiments, the terminal device may copy the target script in response to a triggering instruction of the control 428. The user may use the control 428 to conveniently perform the operation of copying the target script.

As shown in FIG. 4, a title name (e.g., title names 402, 404, 406) corresponding to each script display box 408 may also be displayed above each script display box 408. The title name may include the serial number of the script display box 408 (e.g., serial numbers 1, 2, 3) and the corresponding title, to facilitate the user to know the number of generated target scripts.

Referring back to FIG. 3, the first sub-page 202 may further include options 302, 304 (e.g., second options). The options 302, 304 may be used to switch the style of the target script. For example, the option 302 may represent a first style, and the option 304 may represent a second style.

In some embodiments, the first style may be an unrestricted style, that is, target scripts of all styles are displayed in the second sub-page 234. The user may click the option 302 through the terminal device, so that the target scripts of all styles are displayed in the second sub-page 234. As shown in FIG. 4, in response to the second sub-page 234 displaying the target scripts of all styles, the script display boxes 408 may be displayed in the order of the serial numbers in the title names.

The user may click the option 304 through the terminal device to switch to a target style. In some embodiments, the terminal device may display, in response to switching to the target style through the option 304, a target script corresponding to the target style and a script structure of the target script in the second sub-page.

In some embodiments, a title name 306 may also be displayed above the options 302, 304. For example, the title name 306 may be “script style” to prompt the user of the effect of the options 302, 304.

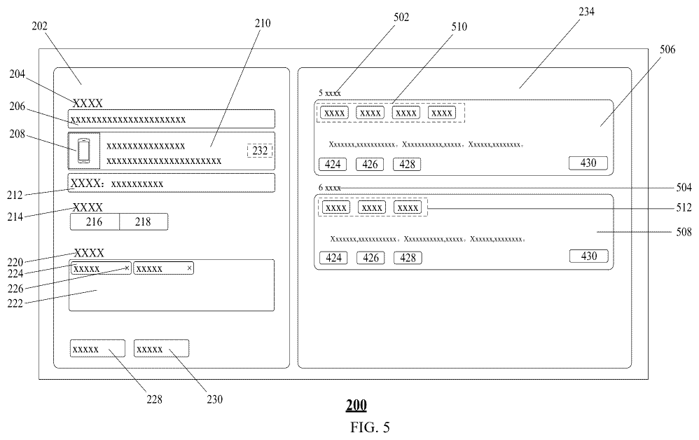

FIG. 5 is a schematic diagram of another example page 200 according to some embodiments of the present disclosure.

As shown in FIG. 5, after the user switches to the target style through the option 304, the second sub-page 234 may display target scripts corresponding to the target style and script structures 510, 512 corresponding to the target scripts in the script display boxes 506, 508. Concurrently, since not all the target scripts are displayed in the second sub-page 234, the serial numbers of the title names corresponding to the script display boxes 506, 508 are displayed in the second sub-page 234. For example, the serial numbers in the title names of the script display boxes 506, 508 corresponding to the target style are 5 and 6, the serial number 5 of the title name 502 corresponding to the script display box 506 and the serial number 6 of the title name 504 corresponding to the script display box 508 are displayed in the second sub-page 234. In this way, the user may check the script content corresponding to the target style according to the demand conveniently through the setting of the option for switching the script style.

Referring back to FIG. 2, the first sub-page 202 may further include a control 230. In response to the content in the input box in the first sub-page 202 does not meet the user's needs, the user may click the control 230 through the terminal device to clear the content in the input box in the first sub-page 202. In some embodiments, the terminal device may clear the content in the input box in the first sub-page 202 in response to a triggering instruction of the control 230. In this way, the operation of the user is facilitated, and the operation time of the user deleting the content in the input box one by one if the content in the input box in the first sub-page 202 does not meet the user's needs is saved.

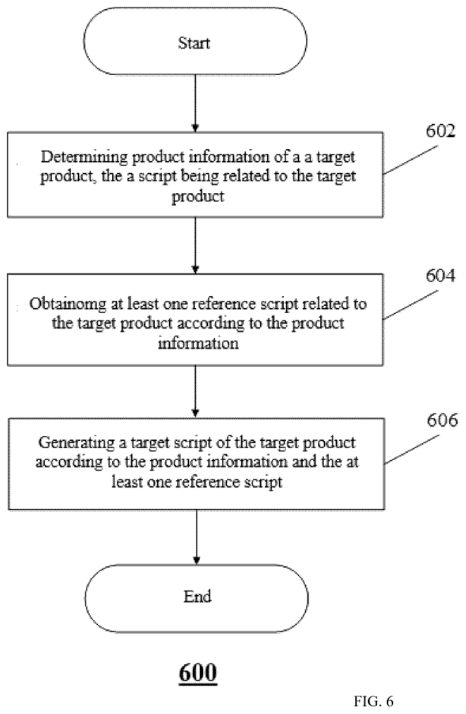

FIG. 6 is a flowchart of an example method 600 for generating a script according to some embodiments of the present disclosure. The method 600 may be performed by the system 100 (for example, the system 100 in FIG. 1A). For example, a user 108 (for example, the user 108 in FIG. 1A) may input product information through a terminal device 102 (for example, the terminal device 102 in FIG. 1A). The terminal device 102 may send the product information to a server 104 (for example, the server 104 in FIG. 1A) in response to receiving the product information. The server 104 may acquire corresponding data (for example, product materials and at least one reference script) from a database 106 (for example, the database 106 in FIG. 1A) according to the product information. Then, the server 104 may generate a target script according to the data, and return the target script to the terminal device 102, so as to display the target script to the user 108 at the terminal device 102. The method 600 may include the following steps.

At step 602, product information of a target product is determined, where a script is related to the target product.

At step 604, at least one reference script related to the target product is obtained according to the product information.

At step 606, a target script of the target product is generated according to the product information and the at least one reference script. In this way, after the user inputs the product information, the terminal device may present the automatically generated script to the user, without manual writing, thereby saving the labor cost and improving the efficiency of producing the script.

As can be seen from the above, the present disclosure provides a method for generating a script, an apparatus, an electronic device, a storage medium, and a product. The method includes: determining product information of a target product, the script being related to the target product; obtaining at least one reference script related to the target product according to the product information; and generating a target script of the target product according to the product information and the at least one reference script. Through the above method, a script of a target product can be automatically generated, without manually writing the script, thereby improving the efficiency of producing the script.

In some embodiments, generating the target script of the target product according to the product information and the at least one reference script further includes: parsing the at least one reference script to obtain reference script information of the at least one reference script; and generating the target script according to the product information and the reference script information. In this way, there is no need to manually write the script, which reduces the labor cost.

In some embodiments, the reference script information includes a reference script structure, and generating the target script according to the product information and the reference script information further includes: generating the target script according to the product information and the reference script structure. In this way, based on the model for generating the script, the reference script structure is used as the benchmark, and the target script may be automatically generated using the product information, which improves the efficiency of producing the script, and reduces the time and labor cost of manually writing the script. At the same time, the threshold of producing the script is reduced, and users without scriptwriting basis may also produce the script through the method provided by the embodiments of the present disclosure.

In some embodiments, generating the target script of the target product according to the product information and the at least one reference script further includes: obtaining product materials corresponding to the product information according to the product information; parsing the product materials to obtain reference product information related to the product materials; and generating the target script according to the reference product information and the at least one reference script. In this way, the script generated based on the product features related to the target product extracted from the product materials can express as many relevant features of the target product as possible, so that the user can accurately understand the features of the target product.

In some embodiments, the reference product information includes first information related to a product feature, and the method further includes: displaying a target page (for example, the page 200 in FIG. 2), to the target page including a first sub-page (for example, the first sub-page 202 in FIG. 2), the first sub-page including a first input box (for example, the input box 222 in FIG. 2); and in response to obtaining the reference product information, displaying the first information in the first input box; and generating the target script according to the reference product information and the at least one reference script further includes: generating the target script according to the first information and the at least one reference script. In this way, the script generated based on the product features related to the target product extracted from the product materials can express as many relevant features of the target product as possible, so that the user can accurately understand the features of the target product.

In some embodiments, the first sub-page further includes a second input box (for example, the input box 310 in FIG. 3), the reference product information further includes second information related to a product application scenario, and the method further includes: in response to obtaining the reference product information, displaying the second information in the second input box; and generating the target script according to the first information and the at least one reference script further includes: generating the target script according to the first information, the second information, and the at least one reference script. The second information is used to generate a script that is in line with the applicable scenario and the suitable audience.

In some embodiments, generating the target script according to the first information, the second information, and the at least one reference script further includes: in response to receiving input information through the first input box and/or the second input box, generating the target script according to the first information, the second information, the input information, and the at least one reference script.

In some embodiments, the first sub-page further includes a first control (for example, the control 228 in FIG. 2) for triggering a script generation operation, the target page further includes a second sub-page (for example, the second sub-page 234 in FIG. 2), and generating the target script according to the reference product information and the at least one reference script further includes: in response to a triggering instruction of the first control, generating the target script according to the reference product information and the at least one reference script; and displaying the target script and a script structure of the target script (for example, the script structures 510, 512 in FIG. 5) on the second sub-page. In this way, the user may produce the target script by inputting the product information and clicking the control, and users without scriptwriting basis may also produce the script using the method provided by the embodiments of the present disclosure, which greatly reduces the threshold of writing the script.

In some embodiments, the script structure includes at least one label (e.g., the labels 410, 412, 414, and 416 in FIG. 4), and displaying the target script and the script structure of the target script on the second sub-page further includes: in response to a triggering instruction of a target label (e.g., the target label 416 in FIG. 4) of the at least one label, highlighting a script content (e.g., the highlighted script content 422 in FIG. 4) in the target script that corresponds to the target label. By triggering the target label to highlight the corresponding script content, it is convenient for the user to find the script content corresponding to each label in the script structure.

In some embodiments, the second sub-page further includes a second control (e.g., the control 430 in FIG. 4) for triggering a video generation operation, and the method further includes: in response to a triggering instruction of the second control, generating a target video including the target script. In this way, there is no need for the user to shoot materials offline and then upload the materials online for editing to produce the video. The user may click the control through the terminal device to generate the target video including the target script, which improves the efficiency of producing the video, while reducing the labor and time costs of video production.

In some embodiments, the first sub-page further includes a first option (e.g., the options 216 and 218 in FIG. 2) for switching an application scenario of the target script, and generating the target script according to the reference product information and the at least one reference script further includes: in response to switching to a target application scenario through the first option, generating a target script corresponding to the target application scenario according to the reference product information and the at least one reference script. In this way, the user may switch the application scenario of the generated target script by clicking the option or the option through the terminal device, which is convenient for the user to adjust the target script to be generated according to the demand.

In some embodiments, the first sub-page further includes a second option (e.g., the options 302 and 304 in FIG. 3) for switching a style of the target script, and displaying the target script and the script structure of the target script on the second sub-page further includes: in response to switching to a target style through the second option, displaying on the second sub-page a target script corresponding to the target style and a script structure of the target script. In this way, the user may check the script content corresponding to the target style according to the demand conveniently through the setting of the option for switching the script style.

The present disclosure provides a method for generating a script, an apparatus, an electronic device, a storage medium, and a product. The method includes: determining product information of a target product, the script being related to the target product; acquiring at least one reference script related to the target product according to the product information; and generating a target script of the target product according to the product information and the at least one reference script. Through the above method, a script of a target product can be automatically generated, without manually writing the script, thereby improving the efficiency of producing the script.

It should be noted that the method of the embodiments of the present disclosure may be performed by a single device, such as a computer or a server. The method of the embodiments may also be applied to distributed scenarios and completed by multiple devices in cooperation with each other. In this distributed scenario, one of the multiple devices may only perform one or more steps in the method of the embodiments of the present disclosure, and the multiple devices may interact with each other to complete the method.

It should be noted that some embodiments of the present disclosure have been described above. Other embodiments are within the scope of the appended claims. In some cases, the actions or steps recited in the claims may be performed in a different order than in the above embodiments and still achieve the desired results. In addition, the processes depicted in the drawings do not necessarily require the specific order or continuous order shown to achieve the desired results. In some implementations, multitasking and parallel processing are also possible or may be advantageous.

Based on the same technical concept, the present disclosure further provides an apparatus 700 for generating a script, corresponding to any of the above methods.

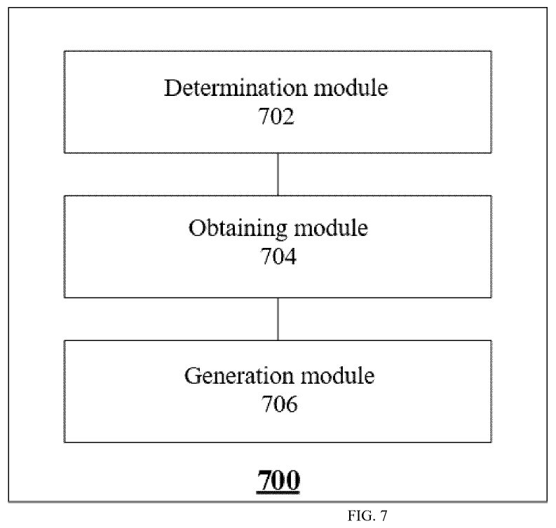

Referring to FIG. 7, the apparatus 700 for generating a script includes:
a determination module 702 configured to determine product information of a target product, the script being related to the target product;
an obtaining module 704 configured to acquire at least one reference script related to the target product according to the product information; and
a generation module 706 configured to generate a target script of the target product according to the product information and the at least one reference script.

The generation module 706 is further configured to parse the at least one reference script to obtain reference script information of the at least one reference script; and generate the target script according to the product information and the reference script information.

The generation module 706 is further configured to generate the target script according to the product information and the reference script structure.

The generation module 706 is further configured to acquire product materials corresponding to the product information according to the product information; parse the product materials to obtain reference product information related to the product materials; and generate the target script according to the reference product information and the at least one reference script.

The apparatus 700 further includes a display module configured to display a target page, the target page including a first sub-page, the first sub-page including a first input box; and in response to obtaining the reference product information, display the first information in the first input box;

The generation module 706 is further configured to generate the target script according to the first information and the at least one reference script.

The display module is further configured to, in response to obtaining the reference product information, display the second information in the second input box;

The generation module 706 is further configured to generate the target script according to the first information, the second information, and the at least one reference script.

The generation module 706 is further configured to, in response to receiving input information through the first input box and/or the second input box, generate the target script according to the first information, the second information, the input information, and the at least one reference script.

The generation module 706 is further configured to, in response to a triggering instruction of the first control, generate the target script according to the reference product information and the at least one reference script; and display the target script and a script structure of the target script on the second sub-page.

The display module is further configured to, in response to a triggering instruction of a target label of the at least one label, highlight a script content in the target script that corresponds to the target label.

The generation module 706 is further configured to, in response to a triggering instruction of the second control, generate a target video containing the target script.

The generation module 706 is further configured to, in response to switching to a target application scenario through the first option, generate a target script corresponding to the target application scenario according to the reference product information and the at least one reference script.

The display module is further configured to, in response to switching to a target style through the second option, display on the second sub-page a target script corresponding to the target style and a script structure of the target script.

For the convenience of description, when describing the above apparatus, it is divided into various modules according to functions for description. Of course, when implementing the present disclosure, the functions of each module may be implemented in the same piece or multiple pieces of software and/or hardware.

The apparatus of the above embodiments is used to implement the corresponding method 600 in any of the above embodiments, and has the beneficial effects of the corresponding method embodiments, which will not be repeated here.

Based on the same technical concept, the present disclosure further provides an electronic device corresponding to any of the above methods. The electronic device includes a memory, a processor, and a computer program stored in the memory and executable by the processor. When the processor executes the program, the method 600 according to any one of the above embodiments is performed.

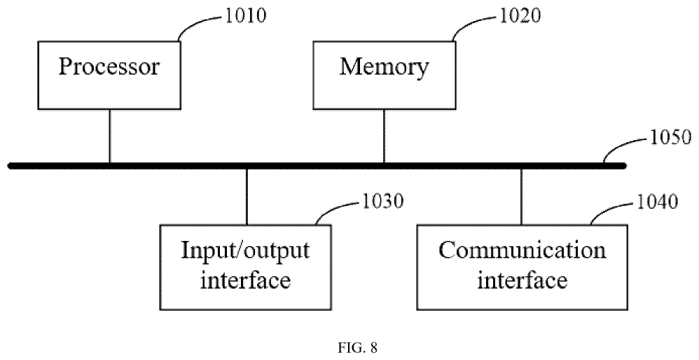

FIG. 8 is a schematic structural diagram of an example electronic device according to an embodiment of the present disclosure. The device may include a processor 1010, a memory 1020, an input/output interface 1030, a communication interface 1040, and a bus 1050. The processor 1010, the memory 1020, the input/output interface 1030, and the communication interface 1040 are connected to each other through the bus 1050 for communication within the device.

The processor 1010 may be implemented by a general-purpose CPU (Central Processing Unit), a microprocessor, an Application Specific Integrated Circuit (ASIC), one or more integrated circuits, etc., and is used to execute related programs to implement the technical solutions provided by the embodiments of the present specification.

The memory 1020 may be implemented in the form of a Read Only Memory (ROM), a Random Access Memory (RAM), a static storage device, a dynamic storage device, etc. The memory 1020 may store an operating system and other application programs. When implementing the technical solutions provided by the embodiments of the present specification through software or firmware, the related program code is stored in the memory 1020 and called by the processor 1010 for execution.

The input/output interface 1030 is used to connect an input/output module to realize information input and output. The input/output module may be configured in the device as a component (not shown in the figure), or may be externally connected to the device to provide corresponding functions. The input device may include a keyboard, a mouse, a touchscreen, a microphone, various sensors, etc., and the output device may include a display, a speaker, a vibrator, an indicator light, etc.

The communication interface 1040 is used to connect a communication module (not shown in the figure) to realize communication and interaction between the device and other devices. The communication module may realize communication in a wired manner (for example, USB, network cable, etc.), or may realize communication in a wireless manner (for example, mobile network, WIFI, Bluetooth, etc.).

The bus 1050 includes a path for transmitting information between various components (for example, the processor 1010, the memory 1020, the input/output interface 1030, and the communication interface 1040) of the device.

It should be noted that although the above device only shows the processor 1010, the memory 1020, the input/output interface 1030, the communication interface 1040, and the bus 1050, in a specific implementation process, the device may also include other components necessary for normal operation. In addition, those skilled in the art can understand that the above device may also only contain components necessary to implement the solutions of the embodiments of the present specification, and may not necessarily contain all of the components shown in the figure.

The electronic device of the above embodiments is used to implement the corresponding method 600 in any of the above embodiments, and has the beneficial effects of the corresponding method embodiments, which will not be repeated here.

Based on the same technical concept, corresponding to any of the above methods, the present disclosure further provides a non-transitory computer-readable storage medium storing computer instructions, where the computer instructions are used to cause a computer to perform the method 600 according to any of the above embodiments.

The computer-readable medium in this embodiment includes permanent and non-permanent, removable and non-removable media, and information storage may be implemented by any method or technology. Information may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassette, magnetic tape, magnetic disk storage, or other magnetic storage devices, or any other non-transmission medium that may be used to store information accessible by a computing device.

The computer instructions stored in the storage medium in the above embodiments are used to cause the computer to perform the method 600 in any of the above embodiments, and have the beneficial effects of the corresponding method embodiments, which will not be repeated here.

Based on the same inventive concept, corresponding to the method 600 described in any of the above embodiments, the present disclosure further provides a computer program product including computer program instructions, where the computer program instructions, when executed on a computer, cause the computer to perform the method 600 in any of the above embodiments. In some embodiments, the computer program instructions may be executed by one or more processors of the computer, so that the computer and/or the processor perform the method 600. Corresponding to the execution subject corresponding to each step in each embodiment of the method 600, the processor that executes the corresponding step may belong to the corresponding execution subject.

The computer program product in the above embodiments is used to cause the computer and/or the processor to perform the method 600 in any of the above embodiments, and has the beneficial effects of the corresponding method embodiments, which will not be repeated here.

Those of ordinary skill in the art should understand that the discussion of any of the above embodiments is only exemplary, and is not intended to imply that the scope of the present disclosure (including the claims) is limited to these examples. Under the inventive concept of the present disclosure, the technical features in the above embodiments or different embodiments may also be combined, and the steps may be implemented in any order, and there are many other changes in different aspects of the embodiments of the present disclosure as described above, which are not provided in detail for the sake of brevity.

In addition, in order to simplify the description and discussion, and in order not to make the embodiments of the present disclosure difficult to understand, the well-known power/ground connections of integrated circuit (IC) chips and other components may or may not be shown in the provided drawings. In addition, the apparatus may be shown in the form of a block diagram to avoid making the embodiments of the present disclosure difficult to understand, and this also takes into account the fact that the details of the implementations of these block diagram apparatus are highly dependent on the platform on which the embodiments of the present disclosure are to be implemented (that is, these details should be completely within the understanding of those of ordinary skill in the art). In the case where specific details (e.g., circuits) are set forth to describe exemplary embodiments of the present disclosure, it is obvious to those of ordinary skill in the art that the embodiments of the present disclosure may be implemented without these specific details or with changes in these specific details. Therefore, these descriptions should be considered as illustrative rather than restrictive.

Although the present disclosure has been described in combination with specific embodiments of the present disclosure, many replacements, modifications, and variations of these embodiments will be obvious to those of ordinary skill in the art based on the above description. For example, other memory architectures (for example, dynamic RAM (DRAM)) may use the discussed embodiments.

The embodiments of the present disclosure are intended to cover all such replacements, modifications and variations that fall within the broad scope of the appended claims. Therefore, any omission, modification, equivalent replacement, improvement, etc. made within the spirit and principle of the embodiments of the present disclosure shall be included in the protection scope of the present disclosure.

What is claimed is:

1. A method for generating a script, comprising:
determining product information of a target product, the script being related to the target product;
obtaining at least one reference script related to the target product according to the product information; and
generating a target script of the target product according to the product information and the at least one reference script.

2. The method according to claim 1, wherein the generating the target script of the target product according to the product information and the at least one reference script further comprises:
parsing the at least one reference script to obtain reference script information of the at least one reference script; and
generating the target script according to the product information and the reference script information.

3. The method according to claim 2, wherein the reference script information comprises a reference script structure, and the generating the target script according to the product information and the reference script information further comprises:
generating the target script according to the product information and the reference script structure.

4. The method according to claim 1, wherein the generating the target script of the target product according to the product information and the at least one reference script further comprises:
obtaining a product material corresponding to the product information according to the product information;
parsing the product material to obtain reference product information related to the product material; and
generating the target script according to the reference product information and the at least one reference script.

5. The method according to claim 4, wherein the reference product information comprises first information related to a product feature, and the method further comprises:
displaying a target page, the target page comprising a first sub-page, the first sub-page comprising a first input box; and
displaying the first information in the first input box in response to obtaining the reference product information;
wherein the generating the target script according to the reference product information and the at least one reference script further comprises: generating the target script according to the first information and the at least one reference script.

6. The method according to claim 5, wherein the first sub-page further comprises a second input box, and the reference product information further comprises second information related to a product application scenario, the method further comprises:
displaying the second information in the second input box in response to obtaining the reference product information;
wherein the generating the target script according to the first information and the at least one reference script further comprises: generating the target script according to the first information, the second information, and the at least one reference script.

7. The method according to claim 6, wherein the generating the target script according to the first information, the second information, and the at least one reference script further comprises:
generating the target script according to the first information, the second information, input information, and the at least one reference script in response to receiving the input information through the first input box and/or the second input box.

8. The method according to claim 5, wherein the first sub-page further comprises a first control for triggering a script generation operation, the target page further comprises a second sub-page, and the generating the target script according to the reference product information and the at least one reference script further comprises:
generating the target script according to the reference product information and the at least one reference script in response to a triggering instruction on the first control; and
displaying the target script and a script structure of the target script on the second sub-page.

9. The method according to claim 8, wherein the script structure comprises at least one label, and the displaying the target script and the script structure of the target script on the second sub-page further comprises:
highlighting script content corresponding to a target label in the target script in response to a triggering instruction on the target label in the at least one label.

10. The method according to claim 8, wherein the second sub-page further comprises a second control for triggering a video generation operation, the method further comprises:
generating a target video containing the target script in response to a triggering instruction on the second control.

11. The method according to claim 5, wherein the first sub-page further comprises a first option for switching an application scenario of the target script, and the generating the target script according to the reference product information and the at least one reference script further comprises:
generating a target script corresponding to a target application scenario according to the reference product information and the at least one reference script in response to switching to the target application scenario through the first option.

12. The method according to claim 8, wherein the first sub-page further comprises a second option for switching a style of the target script, and the displaying the target script and the script structure of the target script on the second sub-page further comprises:
displaying a target script corresponding to a target style and the script structure of the target script on the second sub-page in response to switching to the target style through the second option.

13. An electronic device, comprising a memory, a processor, and a computer program stored in the memory and capable of running on the processor, wherein the processor, when executing the program, implements a method for generating a script, comprising:
determining product information of a target product, the script being related to the target product;
obtaining at least one reference script related to the target product according to the product information; and
generating a target script of the target product according to the product information and the at least one reference script.

14. The electronic device according to claim 13, wherein the processor implements following steps:
parsing the at least one reference script to obtain reference script information of the at least one reference script; and
generating the target script according to the product information and the reference script information.

15. The electronic device according to claim 14, wherein the reference script information comprises a reference script structure, and
the processor implements a following step:
generating the target script according to the product information and the reference script structure.

16. The electronic device according to claim 13, wherein the processor implements following steps:
obtaining a product material corresponding to the product information according to the product information;
parsing the product material to obtain reference product information related to the product material; and
generating the target script according to the reference product information and the at least one reference script.

17. The electronic device according to claim 16, wherein the reference product information comprises first information related to a product feature, and
the processor implements following steps:
displaying a target page, the target page comprising a first sub-page, the first sub-page comprising a first input box; and
displaying the first information in the first input box in response to obtaining the reference product information; and
generating the target script according to the first information and the at least one reference script.

18. The electronic device according to claim 17, wherein the first sub-page further comprises a second input box, and the reference product information further comprises second information related to a product application scenario, and
the processor implements following steps:
displaying the second information in the second input box in response to obtaining the reference product information; and
generating the target script according to the first information, the second information, and the at least one reference script.

19. The electronic device according to claim 18, wherein the processor implements a following step:
generating the target script according to the first information, the second information, input information, and the at least one reference script in response to receiving the input information through the first input box and/or the second input box.

20. A non-transitory computer-readable storage medium storing computer instructions, wherein the computer instructions are used to cause a computer to perform a method for generating a script, comprising:
determining product information of a target product, the script being related to the target product;
obtaining at least one reference script related to the target product according to the product information; and
generating a target script of the target product according to the product information and the at least one reference script.
